(19) United States
(12) Patent Application Publication
(10) Pub. No.: US 2009/0210935 A1
(43) Pub. Date: Aug. 20, 2009

(54) Scanning Apparatus and System for Tracking Computer Hardware

(76) Inventors: Jamie Alan Miley, Richfield, MN (US); Andrew Neal Niese, Rhinelander, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/388,426

(22) Filed: Feb. 18, 2009

Related U.S. Application Data
(60) Provisional application No. 61/029,988, filed on Feb. 20, 2008.

(51) Int. Cl. G06F 21/00; H04L 9/32

(52) U.S. Cl. 726/7; 726/35

(57) ABSTRACT

Apparatus and system for tracking computer hardware consisting of a network interface card configured in promiscuous mode capable of passively listening for OSI layer 2 network traffic on a medium for use in the recovery or location of lost or stolen devices. The device of interest, one located, can then be tracked via signal strength. GPS may also be used to track locations where devices of interest have been located.

### CROSS-REFERENCE TO RELATED APPLICATIONS

This application claims priority to U.S. Provisional Application No. 61/029,988 filed on Feb. 20, 2008.

### FIELD OF INVENTION

The present invention relates to the field of hardware theft prevention, tracking and recovery.

### BRIEF DESCRIPTION OF THE DRAWINGS

FIG. 1 illustrates the components of exemplary scanning apparatus for tracking computer hardware.

FIG. 2 illustrates an exemplary scanning process using a scanning apparatus for tracking computer hardware.

FIG. 3 is a block diagram illustrating the scanning process system for tracking computer hardware.

FIG. 4 illustrates an exemplary scanning process using a GPS device to record latitude and longitude information, along with a notification message which is displayed for a user or stored in the internal database.

FIG. 5 illustrates a scanning process for tracking computer hardware which uses a distributed database.

FIGS. 6a and 6b illustrates a process for detecting movement of a device of interest based on variations in signal strength.

### GLOSSARY

As used herein, the term “network interface component” means a network adapter card, network interface card or any other component which serves the function of allowing a user to connect to a network. As used herein, the term “promiscuous mode” or “Monitor Mode” is any configuration of a network interface component that captures all data frames it detects, rather than only those data frames addressed to it. This is often achieved by the use of custom device drivers; many examples of these types of customized drivers are currently available for the Linux operating system. Promiscuous mode is sometimes known as “monitor mode”.

As used herein, the term “data frame” means a data transmission which includes a specified number and/or sequence of bits delimited by, and including, one or more beginning and ending flag or check sequences. A frame consists of the following but is not limited to; address fields, control fields, a frame check sequence, routing information, synchronization information, device identification, fields indicating subsequent frames are to follow, a field indicating frames type and subtype, management fields, sequencing information fields and any other information capable of being stored within a field.

As used herein, the terms “header” or “derived headers” is information added to or associated with a data frame and which contains information about a data frame which has been received or intercepted, and includes but is not limited to fields indicating signal strength, encryption information, error checking information, time stamping information, a field indicating antenna or sensor, signal quality information, signal noise and any other information capable of being stored within a field consistent with any protocol known in the art. This information is most often derived by the network interface component and corresponding drivers upon interception of data frames. Examples of headers may include, but are not limited to Radiotap and Per-Packet information (PPI) headers.

As used herein, the term “detected network interface component” means a network component or hardware device for which a MAC address or other unique identifying information has been detected.

As used herein, the term, “data frame parsing software component” means a software component or combination of software components that identifies information from the data frames and the corresponding derived, attached headers such as MAC addresses, signal strength, time of capture, and any other information stored in the data frame or corresponding headers. The component then places this information into an array of frame class instance objects stored in RAM (Random Access Memory) that are used for further analysis and comparison.

As used herein, the term “device of interest” means a hardware device which a user desires to track or find.

As used herein, the term “MAC address” means any unique or quasi-unique identifying information for a network interface component under any protocol which may be assigned by a manufacturer, user or any third party. (This is sometimes referred as the Media Access Control address but may be any identifying information that has similar function.)

As used herein, the term “database of MAC addresses” means a plurality of MAC addresses stored in a centralized or distributed database on any hardware device. In addition to MAC addresses, a database of MAC addresses may include additional tracking information, including but not limited to information about a hardware device owner, demographic information, computer serial numbers, manufacture information, date where the devices were last seen, date and time information or any other information. Furthermore, the database of MAC addresses may be used to store information about or contained within captured frames and their corresponding headers, or any information generated during the operation of the apparatus.

As used herein, the term “authentication software component” means a software component which determines whether a user is permitted to modify or access a database or software component.

As used herein, the terms “MAC match” or “hit” means a detected match of a MAC address or other unique identifying information to that of a device of interest when a comparison of such information is made.

As used herein, the term “notification message” means an alert using any signal, text message, audible message or visible user interface known in the art.

As used herein, the term “signal strength” means a measure related to strength of a transmitting signal. Furthermore, signal strengthmay be measured at mulitple time or distance intervals and compared (e.g., used to ascertain relative position or distance).

As used herein, the term “Global Positioning System” or “GPS” means any method of determining position based on longitude and latitude.

As used herein, the terms “time stamp” or “time of arrival” means information indicating when a data frame is received, or when an event occurred.

As used herein, the term “distributed database” means a database that may be stored (in whole or in part) in multiple locations.

As used herein, the term “real time” means occurring during a single user session or time period designated by a user.

As used herein, the term “black list” means a list of MAC addresses that the scanning apparatus/software is specifically looking for. Such a list may include MAC addresses representing devices that are reported lost or stolen, MAC addresses of devices that are unauthorized to be attached/connected to a network, or undesired to be in close physical proximity of a network or scanning-apparatus(es) (in case of wireless signals), or the MAC addresses of devices that are known to be associated with (or in the possession of) a person (or persons) that are undesired to be in close physical proximity of a network or scanning apparatus(es), or any MAC addresses that are in some way deemed to be a threat or potential threat, or that should be ostrasized or tracked by the scanning apparatus(es).

As used herein, the term “white list” means a list of MAC addresses representing computerized-devices (including networking equipment) that are known or recognized, and are to be accepted or “ignored”, or not deemed a security threat.

### BACKGROUND

Laptops and other mobile computing devices are prone to theft. Billions of dollars in proprietary information, configured software, and work product are stored on such devices. Most devices are stored or used, at some point, in an unsecured physical location where they are exposed to risk of theft or where they may accidently be lost.

Most computers and other devices operating on a network adhere to common programming protocols which allow the devices to communicate with each other on a network. Currently, the most common model is the Open Systems Interconnection Reference (OSI) model. This model is a standard reference for ordering the code and software components required for computers and other network devices to communicate.

The OSI Model currently utilizes a “layered” model of communications for computer devices. A layer is a collection of conceptually similar functions and protocols that provides services (i.e., includes interfaces to the layers above and below it) and receives service from the layer above and below it. For example, a layer that provides error-free communications across a network provides the path needed by applications above it, while it calls the next lower layer to send and receive data that makes up the contents of the Information being transmitted.

The OSI model divides network architecture into seven categories, referred to as “layers.” These layers of the model (from “top” to “bottom” are the Application, Presentation, Session, Transport, Network, Data-Link, and Physical layers.)

The OSI model is useful in understanding how certain proprietary software products operate, in particular proprietary software products which may be installed on hardware devices to track them in the event of theft or loss. These software products already known in the art primarily use IP (Internet Protocol) addresses, located at the OSI network layer (OSI layer 3), to narrow down the location of a device to a residence by determining where the device was last used to access the Internet. When a stolen device, which has been configured with one of these proprietary software products, is connected to the Internet, it can notify the company which markets the software and related services of the machine's Internet-facing (external) IP address (which was used to connect the device to the Internet), along with the time it was detected (which is essential in environments where an Internet-facing IP address changes periodically), which is typical in most residential networks. This information, theoretically, can then be used to obtain a court order to obtain records from the Internet service provider regarding what residence had the obtained IP address at the recorded time and/or authorization for law enforcement to search for the stolen device.

This method, known in the art, is currently limited to ascertaining the Internet protocol address of the Internet access device (e.g., a router). Multiple devices and users often connect to the Internet using a single access device. Currently, available technologies are not dedicated to locating a particular computer, but rather to locating the wireless access device the computer is using to connect to the Internet. It is then assumed that the device of interest is in the same residential or commercial space as the Internet access device.

The user of a stolen device may however, be accessing an unsecured Internet access device or may be gaining unauthorized access. Also, there are often multiple users and computers connected to any particular Internet access device. Thus, it may be difficult to obtain a search warrant using information solely obtained from devices of interest configured with proprietary software presently known in the art. Also, if a warrant is issued, it may actually be for the wrong dwelling. This problem is exacerbated in areas where there are a number of residences or locations having wireless access devices in close proximity, such as apartment buildings and dormitories.

In addition to these proprietary software products which make devices traceable, there is also “protocol analyzer” and “packet-sniffing” software products. These products are primarily designed for examining data frames and diagnosing network problems, and may also offer intrusion detection. These programs may also be used as tools to compromise the security of networks.

The protocol analyzers can capture data frames produced by network access devices that are not actually connected to a network, but rather are scanning to determine if networks are available to which they can connect. Devices that are configured to read all data frames on a medium, including those not addressed to it, are said to be configured in “promiscuous” mode. A device operating in this mode is capable of passively scanning for all data frames sent by any device that is broadcasting on the same medium, regardless of whether the frames are actually addressed to the device. A considerable amount of data may be obtained from these frames, including (MAC) addresses, encryption information, channel information, control fields, check sequences, routing information, synchronization information, device identification, fields indicating subsequent frames are to follow, fields indicating frames types and subtypes, management fields, and various address fields or any other information capable of being stored within a frame or header regardless of whether the device sending the data frames is connected to a network. Further, the network interface card and drivers attach derived headers to the frame information, containing derived or calculated information about the frame upon arrival. Examples may include, but are not limited to, time of arrival, signal strength, etc. The purpose of these programs is make data frame information available for viewing.

Two such “protocol analyzer” programs known in the art which scan for data frames and make the information within them visible are Kismet and Wireshark. These programs are free software distributed under the GNU (General Public License.) They are primarily used as intrusion detection systems since they allow a user to see all traffic being passed over the medium. Kismet uses promiscuous mode to capture data frames and parse out information from the frames about wireless access points and client devices attached to the corresponding network. Kismet also employs global positioning technology to overlay wireless network locations on maps. Kismet is often primarily used to look for open, unsecured, or vulnerable wireless networks that can be easily accessed, hacked, or utilized for free. Wireshark is primarily used as a network trouble shooting and analysis tool.

In order to advance the prior art, it is desirable to have a scanning device which has the capability to track and process data frames from layer 2 of the OSI model (or equivalent model), obtained from a device configured in promiscuous or monitor mode, in order to determine whether the particular hardware device is a stolen device or is otherwise a device of interest.

It is further desirable to be able to track a device without the necessity of requiring proprietary software to be installed on the device prior to the time that the device is stolen or otherwise needed to be tracked.

It is further desirable to have a scanning method and apparatus for tracking a hardware device which does not require the device to be connected to the Internet.

### SUMMARY OF THE INVENTION

The present invention is a scanning apparatus comprised of a network interface component and software components which enable the network interface component to scan wireless network/radio frequencies and process data frames to determine the MAC address or MAC addresses associated with devices of interest. Various embodiments of the scanning apparatus disclosed herein may compare the MAC address or addresses obtained by scanning to a MAC address database. The MAC address database may reside within the scanning device, on an external computer or on a distributed network. Various types of authentication software components may limit access to the MAC address database or authorize various levels of privileges to a user.

Still further embodiments of the scanning apparatus identified herein may be configured with additional hardware and software components to generate notifications of a match in a first database with one or more MAC addresses in a second or additional database (MAC match or a hit), and to transmit and/or store a notification message. Still other embodiments may be configured to transform or update one or more databases based on user input, queries, and MAC address matches between one or more databases. Still further embodiments may be configured with software components to measure the signal strength of a device from which a scanned frame is emitted relative to a predetermined point, and/or combined with optional Global Positioning (GPS) software and hardware to determine the location of a device, based on the latitude and longitude of where a particular data frame was captured during the time the scanning apparatus was in range.

### DETAILED DESCRIPTION OF INVENTION

For the purpose of promoting an understanding of the present invention, references are made in the text to exemplary embodiments of a scanning apparatus and system for tracking computer hardware, only some of which are described herein. It should be understood that no limitations on the scope of the invention are intended by describing these exemplary embodiments. One of ordinary skill in the art will readily appreciate that alternate but functionally equivalent hardware and software components may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale, instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related. For example, a MAC database may be a database located on a single computer or which resides on a remote or distributed database.

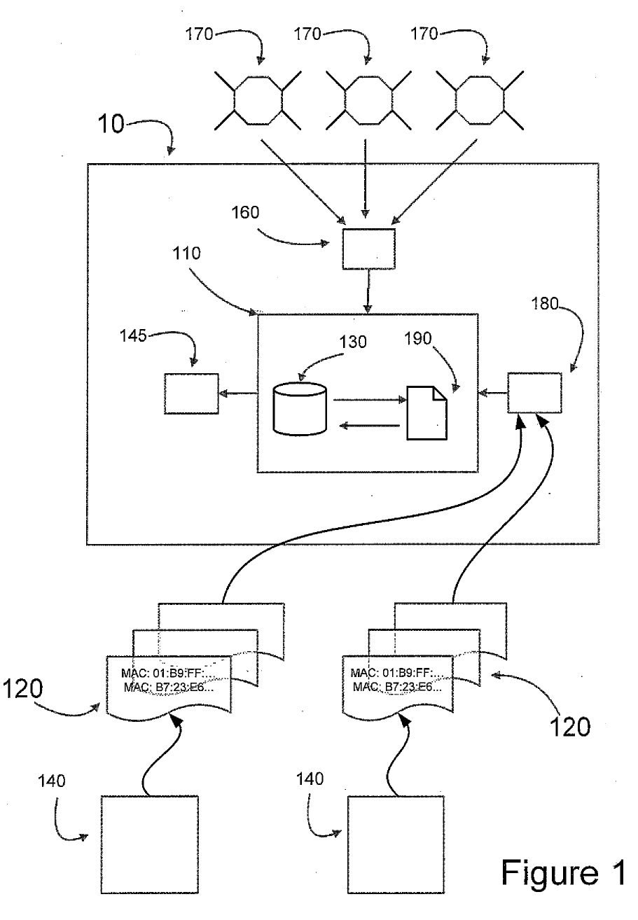

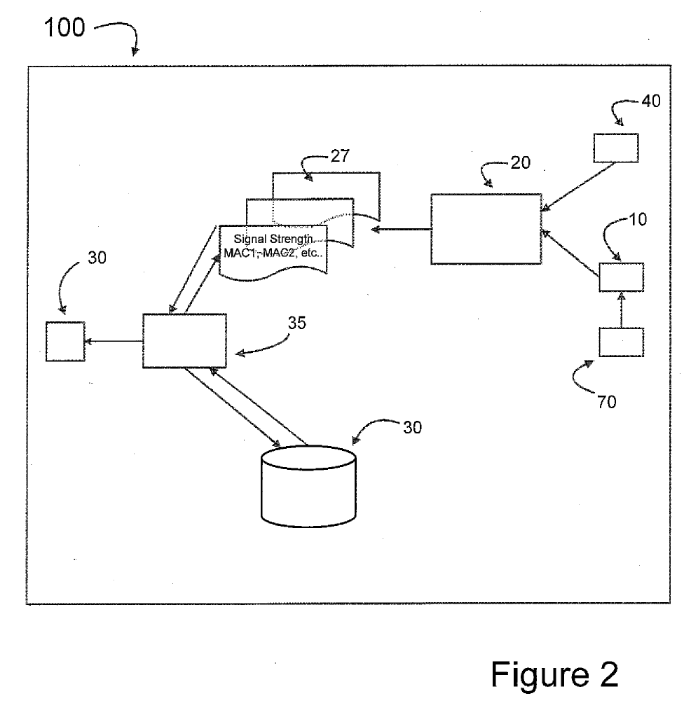

FIG. 1 is an exemplary system for tracking computer hardware 10 using an apparatus for computer hardware 110 described herein, which in the embodiment shown is a computer with a network interface component configured in the promiscuous mode 180 and with parsing and data base comparison software components (discussed in FIG. 2). In the embodiment shown tracking computer hardware 110 is located in a police patrol car 150, which drives on a normal street patrol route. During the patrol shift, apparatus for tracking computer hardware 110 is continuously scanning for wireless data frames 120 emitted by computers within range of the patrol route. When apparatus for tracking computer hardware detects wireless data frames 120 it parses MAC addresses and compares the scanned MAC addresses 190 the MAC address database 130 When apparatus for tracking computer hardware 110 detects a match between a MAC address stored in MAC address database 130 and stolen device 140 by comparing the captured MAC addresses captured in RAM 190, apparatus for tracking computer hardware 110 displays an alert on a visual interface 145 located within patrol car in real time. In alternate embodiments, the alert may be stored or delayed, as a query result, a search result, an alarm, a report, or any type of text communication known in the art. The embodiment shown also includes an optional GPS receiver 160 which is in communication with GPS satellites 170. In alternate embodiments, apparatus for tracking computer hardware 110 may reside on a laptop, desktop computer, PDA or any other electronic device known in the art.

FIG. 2 illustrates the components of an exemplary apparatus for tracking computer hardware 100. The exemplary device is a computer which includes a wireless network adapter card configured in promiscuous mode 10. Tracking apparatus for tracking computer hardware 100 further includes data parsing software component 20 capable of parsing the MAC addresses of one or more intercepted data frames along with any other information that may be contained within a data frame and it's corresponding headers. This software searches data that is transmitted by a wireless network interface component, and looks for a delimiting sequence to define data frames. Within a sequence of data within a frame, existing protocol specifications can be used to determine the location of MAC addresses and any other information that can be contained in a data frame.

Once data frames have been parsed, MAC addresses and other information contained within the data frames and the derived headers are stored in Random Access Memory (RAM) as an array of data frame objects 27, which stores information parsed from the data frames and corresponding headers (e.g., signal strength, one or more MAC addresses, and any other information capable of being stored within a data frame or its corresponding headers). The array of information data frame objects 27 can then be compared to the known MAC address database 30, which is a database of known MAC addresses and other information corresponding to devices to be actively searched for. Ultimately, the information contained in the array of data frame objects is moved from RAM to the system's Internal MAC address database in a separate table that is used to store captured information from the apparatus, 30 and is erased from the RAM.

Apparatus for tracking computer hardware 100 further includes a comparison software component 35 which is a software component which may reside on a distributed network system and which is capable of comparing captured MAC addresses to MAC addresses stored in a database 30. A MAC database can reside on one or more computers, but is comprised of MAC addresses of computers which are stolen, lost or otherwise devices or interest.

In the embodiment shown, MAC address database is a database which may be queried to indicate a match between at least one captured MAC address and at least one other MAC address in MAC address database 30. In various embodiments, MAC address database 30 may reside on an external computer or on a distributed network.

The embodiment shown further includes an optional GPS receiver 40. The GPS receiver allows the system to locate the latitude and longitude of the apparatus at the time when data frames are captured, and then records this information for any or all frames that are captured. This information is also stored in the array of data frame objects 27, and ultimately is moved to the internal database with the array of data frame objects.

Various embodiments of this invention may optionally include an external antenna 70 that may optionally be attached to the 802.11 (or other protocol) adapter to extend the range at which it can receive or send data frames. Ideally this external antenna would be removable or detachable.

In other embodiments the GPS device 40 may be a reciever that is selectively connected to the computer, either by removable interface (e.g., USB, PCMCIA, Firewire, etc) or by actual embedment into the computer. The GPS device 40 would be accessed by the software to accurately record the location (latitude and longitude coordinates) of where the invention is operating. Then the software, if a GPS unit is attached, may use changes in signal strength due to the scanning systems movement to approximate the latitude and longitude of the signal origin or device of interest it is tracking. To determine the approximate latitude and longitude of the 802.11 (or other protocol) signal source, the tracking system must be moving, unless there were three different antennas used in conjunction for triangulation (a stationary method would require three or more antennas). Since the 802.11 (or other protocol) radio signal is broadcast in an omni-directional manner from the source, one can calculate the approximate relative location of the source by carefully examining the changes in signal strength as the tracking system is in motion.

In still other embodiments, a network or Internet connection may be optionally used to update the information in the data set from an external source. For example, if an organization's wireless device were to suddenly go missing, the organization could report the missing device (and its MAC address) to a central database or data set that gets distributed to all users of the detection system to allow the device to be actively searched for. A network connection would enable the software to update its local data-set with a central, up-to-date data set every time it is run or while it is running.

This actual network connection used to update the data set could be manifested in a number of ways, whether through physical network cables (fiber optic, Ethernet, phone lines, etc.) or by a wireless networking system (Infrared, 802.11 Wi-Fi, Microwave, etc.) or whether across a small local area network or across the Internet.

Although it would be preferable and more convenient to use a network connection to update the data set, it would not strictly be necessary. The scanning system's local data-set could also be updated by downloading a newer copy from a USB flash-drive, floppy disk, compact disc, or other external media.

In the embodiment shown database of MAC address database 30 may reside on an external computer and is accessed remotely by scanning apparatus for tracking computer hardware 100. In other embodiments, the database of MAC addresses may be stored internally or on a distributed database.

With respect to MAC address database 30, it should be understood that apparatus for tracking computer hardware 100 may update its internal database from a larger database, referencing all of the data from the larger database or only a smaller subset.

In the embodiment shown, tracking apparatus for tracking computer hardware 100 further includes a user interface 50 to generate a notification when a MAC address that has been obtained using scanning apparatus for tracking computer hardware 100 matches a MAC address in the database 30.

Apparatus for tracking computer hardware 100 may further include GPS receivers 40 to continually record the present latitude and longitude of the scanning system each time a subsequent “hit” frame is found (a “hit” is when a data frame is detected that contains the MAC address of a device-of-interest). By correlating the latitude and longitude as the scanning apparatusmoves in combination with the signal strength of each “hit” packet, apparatus for tracking computer hardware 100 may calculate the approximate coordinates where the device is located.

In embodiments which do not include GPS receivers 40, signal strength will be the primary mode of tracking and locating a device of interest. A user may be able to then enter his or her current location at different hit locations to triangulate the location of the device of interest. The user can do this for multiple subsequent hits, and when correlated with the signal strength of each hits the information can be analyzed to paint a picture of where the device is located.

It should be understood that apparatus for tracking computer hardware 100 does not rely upon the IP (Internet Protocol) address of the computer or device in question to find its physical location, and also does not rely on the use of a modem, telephone line, or Internet connection to “phone home” and report its location. Rather, apparatus for tracking computer hardware 100 intercepts 802.11 (or other protocol) frames that are broadcast from wireless devices and uses uniquely-identifiable. information within them, while simultaneously identifying and tracking the broadcasting device. It should be understood that this may be the access point on a network containing a device, especially in situations where one is looking for a device that is connected to the network via hard-wired means.

In various embodiments, apparatus for tracking computer hardware 100 may be a laptop, Smartphone, network router, TV, etc. with 802.11 (or other protocol) technology, or any other computer hardware device or component capable receiving a signal transmitted within range of the device of interest. We may also search for a laptop, Smartphone, network router, TV, etc. with 802.11 (or other protocol) technology or any other computer hardware device or component capable of sending a signal transmitted within range of the scanning apparatus.

The present tracking system captures 802.11 (or other protocol) signals and uses what is known as a MAC (Media Access Control) address to locate and track a device. This unique way of tracking a device by listening for its MAC address in transmitted radio waves would not be considered an obvious invention, because this use of a MAC address is outside the scope of their current intended use, which is to uniquely identify a piece of hardware “within” a network. The system will use the MAC address from “outside” the network. MAC addresses act as a unique hardware identifier so that frames can be properly routed within a network's data-link layer (OSI layer 2).

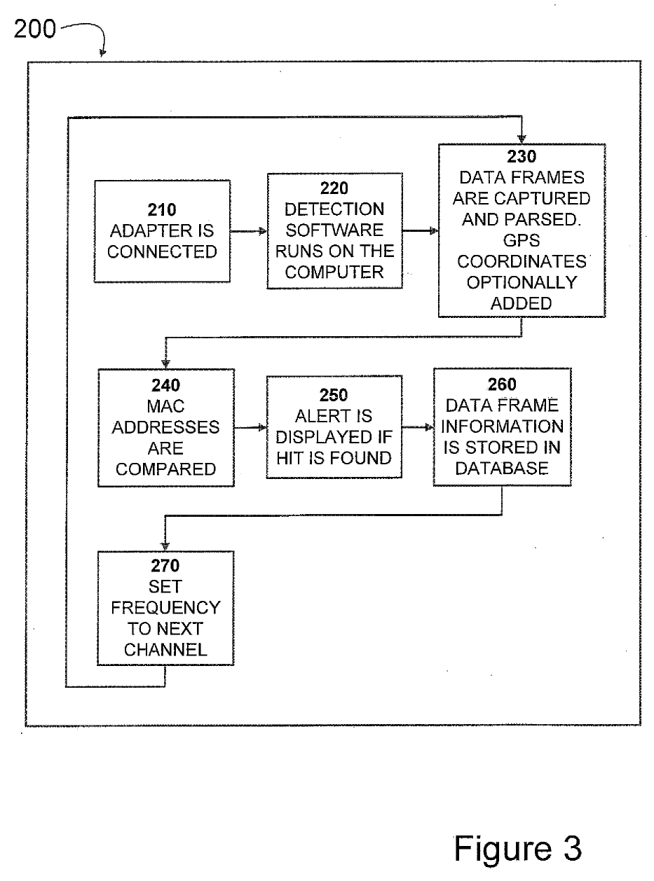

FIG. 3 illustrates an exemplary hardware detection process 200 using a scanning apparatus for tracking computer hardware.

In Step 210, an 802.11 (or other protocol) adapter is connected to the computer, so that data may be captured. The adapter itself could be plugged-in, such as a USB or PCMCIA connection, or it could be embedded into the computer.

In Step 220, detection software runs on the computer, either by directly accessing the computer hardware, or by using an operating system which accesses the hardware on the software's behalf. The detection software detects and activates the attached 802.11 (or other protocol) network interface component and instructs it to start collecting frames in detectable range by setting the adapter to promiscuous mode. Frames are collected by the adapter and sent to the software program (through the computer hardware interface) for analysis.

In Step 230, each 802.11 (or other protocol) data frame that is captured is analyzed to determine the MAC address of the device that generated the frame. In the embodiment shown, every frame that is collected and passed from the adapter is analyzed to extract the MAC addresses (or other unique identifying information) embedded within it. In the embodiment shown, this is accomplished by a parsing algorithm in the software that takes a collected buffer filled with captured bytes and parses it into its individual frames for further analysis. In embodiments containing an optional GPS receiver, the latitudinal and longitudinal coordinates from the scanning apparatus is also recorded when the frame is analyzed and this information is stored in an array of frame objects.

Step 240 The MAC addresses in each data frame object are compared to the MAC addresses of known devices of interest, which are contained within the internal MAC address database.

In Step 250, Alert notification message and information is displayed to user or stored within internal database if a MAC address match is found.

In Step 260, Information about data frames and information parsed from data frames is stored in database.

In Step 270, Protocol frequency is set to next channel on medium if channels exist, as they do with the IEEE 802.11 wireless protocol. The process is then repeated.

Multiple MAC addresses can be embedded in a single packet (data frame) and identified by the system described herein. For example, these addresses can represent the packet's destination, source, BSSID, or a distribution system receiver or transmitter address, or any other information relative to a device or data frame known in the art. The destination MAC address represents the MAC address of the network device belonging to the computer that is the intended final recipient of the packet (data frame). The BSSID (Basic Service Set Identifier) MAC address represents the MAC address of the wireless access point to which the source is connected (in infrastructure-based networks). The Transmitter and Receiver MAC addresses may be used to represent the MAC addresses of networking hardware used to relay a data frame from its source to its destination, if a direct route is not possible.

In the embodiment shown, the primary focus is on Source and Destination MAC addresses, as these are the addresses that are typically associated with end-point computers on a network, and not the devices used to relay their wireless messages. However, the software may provide an option to collect and examine all of the MAC addresses within the packet, because there could be instances where the user would wish to find devices that are part of a distribution system (EG. A wireless router or access point). Additionally, BSSID addresses will be recorded when the MAC address in the data set is matched to a MAC address in an intercepted packet, because this represents an association (or connection) between the computerized device to be found and an access point. This represents that the AP and “device-of-interest” are connected, and so they are likely in proximity to each other. Thus both the MAC addresses on the AP and device-of-interest can then be monitored to better-narrow down the device-of-interest's physical location

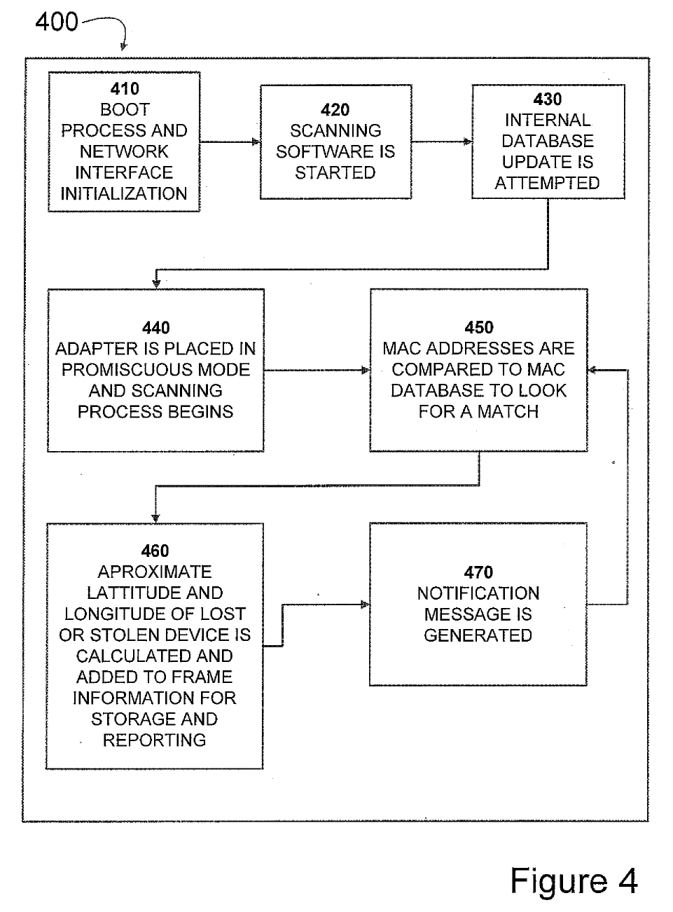

FIG. 4 illustrates a process 400 using an exemplary data tracking system describe herein,

In Step 410, computer powers up and boots the operating system, which recognizes and interfaces with the network interface card, usually through a promiscuous mode enabled device driver.

In Step 420, the scanning software is run. The promiscuous mode enabled device driver (referenced from Step 410) is recognized after the operating system loads.

In Step 430, scanning software attempts to update the internal database of MAC addresses to search for (devices of interest) from an external source, such as a distributed database accessed by the Internet, a local network, mobile storage device, etc.

In Step 440, the scanning software interfaces with the network adapter and places it in monitor mode (promiscuous mode), which allows it to capture all available 802.11 (or other protocol) frames in detectable range. The software instructs the adapter to continually hop across all available channels in the 802.11 (or other protocol) frequency spectrum (currently 11 in US hardware and 14 in European hardware for 802.11 a/b/g networks, newer 802.11N networks are a bit more complex and use sub-channels in conjunction with primary channels), so as to capture as many frames as possible on all 802.11 (or other protocol) frequencies. As frames are collected, the software analyzes them and reads the MAC addresses, comparing them with the database of flagged MAC addresses (devices of interest). Matches are flagged or logged along with the signal strength, time of detection, GPS coordinates at the time of detection (if available), and other important information. If a match is made the search range may be narrowed to only scan the channel where the match was found to allow for more fluid signal strength detection and to maximize the number of frames captured from the device of interest. A report is generated about the flagged hardware based on signal strength, time, approximate location, reason for flag, and wireless channel. This information can be used for entry into optional hand held wireless unit for easier mobility in detection. This is most useful in cases such as determining a side of a duplex or specific unit (apartment, suite, etc.) within a building.

In Step 450, each captured MAC address is compared to the MAC address in a MAC database to determine a MAC match hit. As MAC addresses are collected by the adapter, they are compared to all of the MAC addresses in the MAC database. In the application of hardware-recovery, this data set would contain a list of all of the wireless devices that needed to be found, uniquely identifiable by their MAC addresses. If the adapter captures a packet that contains the same MAC address as a device in the dataset, the software would determine that a match had been made, and that a device of interest had been found.

In Step 460, in certain embodiments containing an optional GPS receiver, the comparison software component attempts to calculate the approximate latitude and longitude of the actual hardware being looked for based on 802.11 signal strength changes in conjunction with the changes in latitude and longtude of the scanning apparatus.

In Step 470, a notification message is generated indicating when a hit has been found, and is displayed on a user interface, which may be audio, visual or a text message, the message may also be recorded in the internal database for later analysis and record keeping.

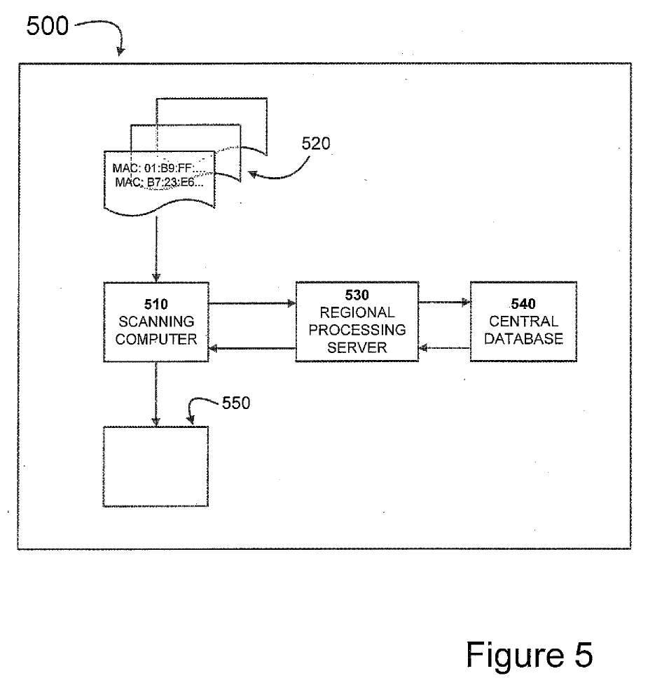

FIG. 5 Illustrates the components of an exemplary hardware tracking system 600 for tracking computer hardware which uses a distributed database. In the embodiment shown, scanning computer 510 is used to collect data frames 520 and then pass them on to server 530 for interpretation. Server 530 can either be used in conjunction with tracking computer 510, or configured to interpret a data frame on its own and parse MAC addresses and other data contained within data frames and their corresponding headers. Server 530 may then pass the MAC addresses to the central database system 540, or may utilize a database stored on server 530 for comparison purposes. Expemplary hardware system may then generate a notification message and display the notification on user interface 550 to indicate a match based on a query (a “hit”) which may be local, remote, or a simultaneous display of a notification at multiple locations.

In various embodiments of tracking system 500, user interface may display additional captured data relating of the detected device or for a device having a MAC address registered in the MAC address database. Such additional data may include make, model number, serial number, a physical description of the device, the name, address, and other identifying information or contact information of the owner, the last known location of the device, time the device was last seen, and any other information which may be useful in identifying or finding the lost device, and returning it to its owner.

It should be further understood that an electronic device to be found may in fact have more than one MAC address. For example, a laptop may have one MAC address for its wireless adapter, and another MAC address for its wired ethernet adapter. It also be understood that a MAC address need not only include a number assigned by a manufacturer or other third party, but may also be any unique or quasi-unique identifying information present in wireless or wired-network packets (data frames) that uniquely identifies a device of interest.

In various embodiments, apparatus for tracking computer hardware may further be used to detect an unlawful or unauthorized connection or attatchment (of a computer, wireless access point, router or other piece of networkable equipment) to a computer network (via computer, wireless access point, router or other networkable equipment) that contains an 802.11 (or other protocol) wireless access point. This may be achieved by having a list of all access points belonging to an organization in a “white list” and/or having a list of 802.11 (or other protocol) capable computer-devices allowed to be on those access points. The unauthorized connection could be detected when a packet (data frame) is intercepted (wirelessly, or on the wire) containing a MAC address not in the “white list” of authorized computer-devices.

In various embodiments, hardware tracking devices may be used to detect potential security threats due to unauthorized persons and/or the computerized devices they are using (carrying, driving, etc) due to the proximity of foreign 802.11 (or other protocol) signals. One or more 802.11 (or other protocol) compliant wireless adapter(s) may be enabled to capture frames in promiscuous mode. The 802.11 (or other protocol) adapter continually scans for 802.11 (or other protocol) frames and associated MAC address information stored in the frames. When a data frame with an unrecognized MAC address is intercepted (e.g, a MAC address not in a white-list), or when a packet is intercepted containing the MAC address associated with a known or suspected threat (e.g, a MAC address in a black-list) a notification is sent to the user, and the software begins to track the signal strength of the foreign device. Location and movement of the foreign computerized device may further be detected/approximated by changes in the signal strength in relation to the known location(s) of the scanning device(s) that received the data frames. For example, if two 802.11 (or other protocol) devices were used in conjunction (adapters A and B), the user would know that the device was moving away from Adapter A, and toward Adapter B, by observing a decreasing signal strength on Adapter A and an increasing signal strength on Adapter B.

An example of this is the use of the invention to detect the presence of unknown or unauthorized devices around the perimeter of a secure area. Various embodiments of the scanning apparatus and system for tracking computer hardware may include additional “black list” and “white list” database features.

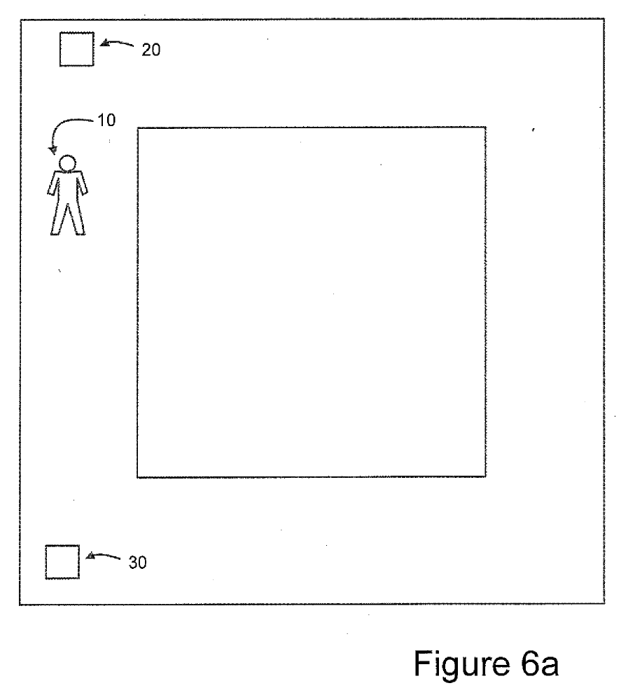

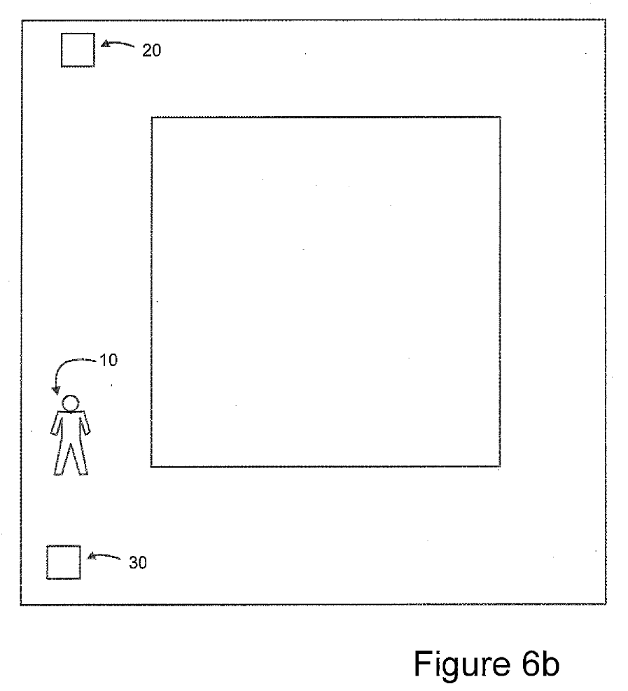

FIG. 6a and FIG. 6b illustrates a process for detecting movement of a device of interest based on variations in signal strength. In the exemplary embodiment shown, in FIG. 6a suspect 10 (who is a person carrying a device of interest) is in close proximity to location 20 of a scanning point in the corridor of a building. FIG. 6b illustrates a second reading of the MAC address of a device of interest. This reading shows an increased signal strength in relation to station 30 and a decreased signal strength (weaker reading) in relation to station 20.

Thus, it can be inferred that suspect 10 has now moved closer to station 30. Similarly, other locations and movement patterns can be detected by changes in signal strength read at multiple stations.

What is claimed is:

1. A hardware tracking apparatus comprised of:
at least one network interface component configured to operate in promiscuous mode to detect at least one network data frame generated by at least one detected network interface component;
a data frame parsing software component which interprets the data included within said at least one network data frame to determine the MAC address of said at least one detected network interface device;
a database of MAC addresses to which said MAC address of said at least one detected network interface device may be compared using a software component for comparison;
an authentication software component which evaluates the credentials of a user to determine the user's authority to access said database of MAC addresses; and
a user interface which indicate the presence of a MAC address match.

2. The hardware tracking apparatus of claim 1 wherein said apparatus further includes a software component which generates a notification message.

3. The hardware tracking apparatus of claim 1, wherein said database of MAC addresses is an external data base which is accessed by said computer scanning apparatus.

4. The hardware tracking apparatus of claim 1, wherein said database of MAC addresses is a distributed data base which is accessed by said computer scanning apparatus.

5. The hardware tracking apparatus of claim 1, which further includes a software component to measure the signal strength of said at least one detected network access device.

6. The hardware tracking apparatus of claim 5, which further includes Global Positioning System receiver which tracks the coordinates of a detected network access device.

7. The hardware tracking apparatus of claim 6, which continually updates said coordinates by processing a plurality of said at least one network data frames having time stamps.

8. A hardware tracking system comprised of:
at lease one network interface device configured to operate in promiscuous mode to detect at least one network data frame generated by at least one detected network interface device;
a data frame parsing software component which interprets the data included within said at least one network data frame to determine the MAC address of said at least one detected network interface device; and
a distributed database of MAC addresses to which said MAC address of said at least one detected network interface device may be compared using a software component for comparison;
an authentication software component which evaluates the credentials of a user to determine the user's authority to access said database of MAC addresses.
a user interface which indicate the presence of a MAC address match.

9. The hardware tracking system of claim 8 wherein said system further includes an interface which generates a notification message.

10. The hardware tracking system of claim 8, which further includes a software component to measure the signal strength of said at least one detected network access device.

11. The hardware tracking system of claim 10, which further includes Global Positioning System receiver software which tracks the coordinates of a detected network access device.

12. The hardware tracking system of claim 11, which continually updates said coordinates by processing a plurality of said at least one network data frames having time stamps.

13. The hardware tracking system of claim 8 wherein said distributed database of MAC addresses further includes a white list of MAC addresses.

14. The hardware tracking system of claim 8 wherein said distributed database of MAC addresses further includes a black list of MAC addresses.

15. The hardware tracking system of claim 8 wherein said distributed database of MAC addresses further includes a list of MAC addresses which are processed according to a set of predetermined protocols.

16. A mobile MAC address scanning system comprised of:
at lease one network interface device configured to operate in promiscuous mode to detect at least one network data frame generated by at least one detected network interface device;
a data frame parsing software component which interprets the data included within said at least one network data frame to determine the MAC address of said at least one detected network interface device and store said MAC address of said at least one detected network device for retrieval;
a distributed database of MAC addresses which is dynamically updated and to which said MAC address of said at least one detected network interface device may be compared;
an authentication software component which evaluates the credentials of a user to determine the user's authority to access said database of MAC addresses; and
a user interface which indicates the presence of a MAC address match.

17. The system of claim 16 wherein said system generates a notification message of said MAC address in match in real time.

18. The system of claim 16, which further includes a software component to measure the signal strength of said at least one detected network access device.

19. The system of claim 16, which further includes a Global Positioning System receiver which tracks the longitude and latitude coordinates of a detected network access device.

20. The system of claim 16, which continually updates said coordinates by processing a plurality of said at least one network data frames each having a time stamp.
